(19) United States
(12) Patent Application Publication
(10) Pub. No.: US 2025/0150984 A1
(43) Pub. Date: May 8, 2025

(54) RSSI Based Transmit Power for BLE Advertisers

(71) Applicant: Silicon Laboratories Inc., Austin, TX (US)

(72) Inventor: Wesam Koraim, Espoo (FI)

(21) Appl. No.: 18/387,978

(22) Filed: Nov. 8, 2023

(51) Int. Cl. H04W 52/24; H04W 52/36

(52) U.S. Cl. CPC H04W 52/245; H04W 52/367

(57) ABSTRACT

A system and method for reducing power consumption in an advertiser in a Bluetooth network is disclosed. The advertiser transmits the advertisement in accordance with the Bluetooth protocol and listens for scan request packets. If a scan request packet is received from a remote device, the advertiser determines the signal strength of the incoming scan request packet and adjusts its transmit power based on this determination. This determination may allow the advertiser to reduce its transmit power if the remote device that transmits the scan request is believed to be nearby. The advertiser then transmits a scan response packet using this adjusted transmit power. This technique may be used for both legacy and extended advertising.

### FIELD

This disclosure describes a system and method for reducing transmit power for a Bluetooth Low Energy (BLE) advertiser.

### BACKGROUND

The Bluetooth protocol is one of many wireless network protocols that are currently in use. The Bluetooth protocol is commonly used to connect smartphones to watches, headphones, speakers, and other accessories. Bluetooth Low Energy utilizes 40 physical channels in the 2.4 GHZ ISM band, each channel separated by 2 MHz.

One of the features of the Bluetooth protocol is the use of advertisements. An advertisement is a packet that is broadcast by an advertiser using predefined advertising channels. Devices, which may be referred to as scanners, listen for these advertisements. These advertisements may be transmitted at regular intervals or periods.

In some embodiments, the scanners may request additional information from the advertiser. This request requires the advertiser to transmit a response to the requesting scanner. Note that, in many embodiments, the advertiser may be battery powered, so the transmission of these advertisements and responses consumes battery power.

Therefore, it would be beneficial if there was a system and method that allowed the advertiser to conserve transmit power while remaining compliant with the Bluetooth specification.

### SUMMARY

A system and method for reducing power consumption in an advertiser in a Bluetooth network is disclosed. The advertiser transmits the advertisement in accordance with the Bluetooth protocol and listens for scan request packets. If a scan request packet is received from a remote device, the advertiser determines the signal strength of the incoming scan request packet and adjusts its transmit power based on this determination. This determination may allow the advertiser to reduce its transmit power if the remote device that transmits the scan request is believed to be nearby. The advertiser then transmits a scan response packet using this adjusted transmit power. This technique may be used for both legacy and extended advertising.

According to one embodiment, a method of transmitting advertisements from an advertiser to a Bluetooth device in a Bluetooth network is disclosed. The method comprises wirelessly transmitting, from the advertiser, an advertisement; and in response to receiving a scan request packet from the Bluetooth device in response to the advertisement: determining at the advertiser, the RSSI of the scan request packet; setting an adjusted transmit power based on the RSSI of the scan request packet; and transmitting, from the advertiser, a scan response packet to the Bluetooth device using the adjusted transmit power. In some embodiments, the setting is performed using a look up table. In some embodiments, the setting is performed using an algorithm or equation. In some embodiments, the adjusted transmit power varies inversely with the RSSI. In some embodiments, a difference between a minimum adjusted transmit power and a maximum adjusted transmit power is at least 10 dBm. In some embodiments, the scan response packet is transmitted using a different transmit power than is used for the advertisement. In some embodiments, after transmitting the scan response packet, the advertiser switches to a different channel and repeats the sequence. In some embodiments, the advertisement, the scan request packet and the scan response packet are transmitted on an advertising channel. In some embodiments, the advertisement, the scan request packet and the scan response packet are transmitted on a data channel. In certain embodiments, information to be sent from the advertiser to the Bluetooth device in response to the scan request packet cannot all be contained within the scan response packet and wherein the advertiser transmits additional response packets using the adjusted transmit power. In certain embodiments, an initial advertisement is transmitted on an advertising channel prior to transmitting the advertisement on the data channel.

According to another embodiment, a Bluetooth network device is disclosed. The Bluetooth network device comprises a read circuit to receive, demodulate and decode an incoming packet and to determine a received signal strength indicator (RSSI) for the incoming packet; and a power amplifier configured to transmit packets at a selectable transmit power; a processing unit; and a memory device, in communication with the processing unit, containing instructions, which when executed by the processing unit, enable the Bluetooth network device to: wirelessly transmit an advertisement; and in response to receiving a scan request packet in response to the advertisement: determine the RSSI of the scan request packet; set an adjusted transmit power based on the RSSI of the scan request packet; and transmit a scan response packet using the adjusted transmit power. In some embodiments, the processing unit uses a look up to set the adjusted transmit power. In some embodiments, the processing unit uses an equation or algorithm to set the adjusted transmit power. In some embodiments, the adjusted transmit power varies inversely with the RSSI. In some embodiments, the advertisement and the scan response packet are transmitted on an advertising channel. In some embodiments, the advertisement and the scan response packet are transmitted on a data channel. In some embodiments, information to be sent from the Bluetooth network device in response to the scan request packet cannot all be contained within the scan response packet and the instructions, which when executed by the processing unit, enable the Bluetooth network device to transmit additional response packets using the adjusted transmit power. In some embodiments, the instructions, which when executed by the processing unit, enable the Bluetooth network device to transmit an initial advertisement on an advertising channel prior to transmitting the advertisement on the data channel. In some embodiments, the scan response packet is transmitted using a different transmit power than is used for the advertisement.

### BRIEF DESCRIPTION OF THE DRAWINGS

For a better understanding of the present disclosure, reference is made to the accompanying drawings, in which like elements are referenced with like numerals, and in which:

FIG. 1 illustrates a timing diagram showing message exchange during legacy active scanning;

FIGS. 2A-2B illustrate timing diagrams showing message exchange during active scanning using extended advertising;

FIG. 3A shows a block diagram of a Bluetooth network device;

FIG. 3B shows a Bluetooth network with an advertiser and multiple Bluetooth network devices;

FIG. 4 shows a flowchart implementing the modified advertisement sequence for legacy advertising according to one embodiment; and

FIG. 5 shows a flowchart implementing the modified advertisement sequence for extended advertising according to one embodiment.

### DETAILED DESCRIPTION

This disclosure describes improvements to the Bluetooth advertisement mechanism. These improvements are intended to reduce power consumption of the advertiser. However, before describing these improvements, an explanation of various features defined by the Bluetooth specification is provided.

Non-connectable and non-scannable undirected advertising, also referred to as legacy advertising, is a form of broadcast from a sending device, referred to as the advertiser, to unidentified and unenumerated recipients. The sending device does not expect any of the recipients to connect. The Bluetooth protocol also defines active and passive scanning. In passive scanning, the Bluetooth device simply listens for incoming advertisements and then processes whatever it has received. In active scanning, the Bluetooth device that receives a scannable advertisement, may issue a scan request to the advertiser. This prompts the advertiser to respond to the scan request message. The scan response message may contain additional advertisement data.

Bluetooth advertisement payloads are encoded AD as structures. An AD structure has a triplet, made up of length, AD Type and AD Data, where the length field records the combined byte count of the AD Type and AD Data fields, AD Type defines the type of data to follow, and AD Data contains the actual data to be transmitted. An Advertising Protocol Data Unit (PDU) may include multiple AD structures in it, concatenated one after another, while adhering to the PDU payload length limitations.

For each advertisement, the same PDU may be transmitted three times, once for each Bluetooth Low Energy advertising channel (i.e., channels 37, 38 and 39). This sequence is known as an advertising event. Additionally, the interval between transmission on two consecutive advertising channels must be less than 10 milliseconds.

In the Bluetooth core specification, active scanning is based on scannable undirected advertisements, using ADV_IND PDUs, which can contain a payload of up to 31 bytes. The scan request is encoded using a SCAN_REQ PDU, which contained no payload, only the Bluetooth address of the advertiser and the Bluetooth address of the device requesting the scan response. Finally, the scan response is encoded using a SCAN_RSP PDU, which may contain a payload of up to 31 bytes. Note that all of these payloads are encoded as AD structures.

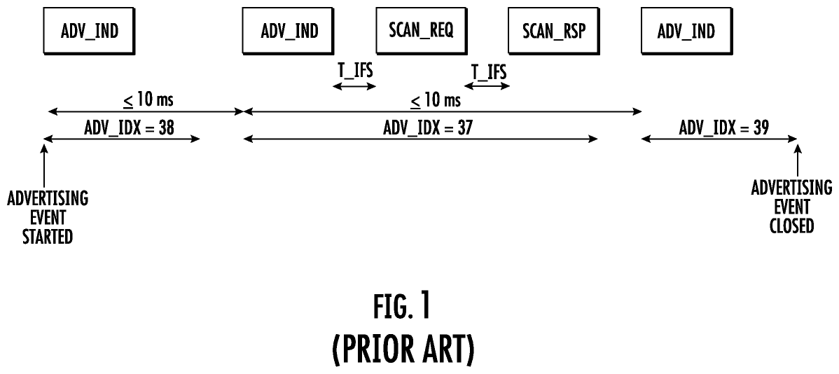

FIG. 1, taken from the Bluetooth Core specification, illustrates the message exchange during active scanning. The advertisement is transmitted on all three advertising channels. Note that the scan exchange must than 10 milliseconds. However, unlike nonscannable advertisements, these advertisements are transmitted using ADV_IND PDUs. Further, a device that is listening on one of the advertising channels, such as channel 37, may request a scan, using a SCAN_REQ PDU. This request is followed by a scan response, using a SCAN_RSP PDU. Note that there are strict timing requirements regarding the SCAN_REQ and SCAN_RSP PDUs. As shown in FIG. 1, the SCAN_REQ and SCAN_RSP PDUs must be transmitted after a duration, defined as the inter-frame spacing period (T_IFS), after receipt of the ADV_IND PDU and SCAN_REQ PDU, respectively. This T_IFS is currently defined as 150 microseconds. After the scan request and response have been exchanged, the advertiser than moves to the next advertising channel, as shown in FIG. 1.

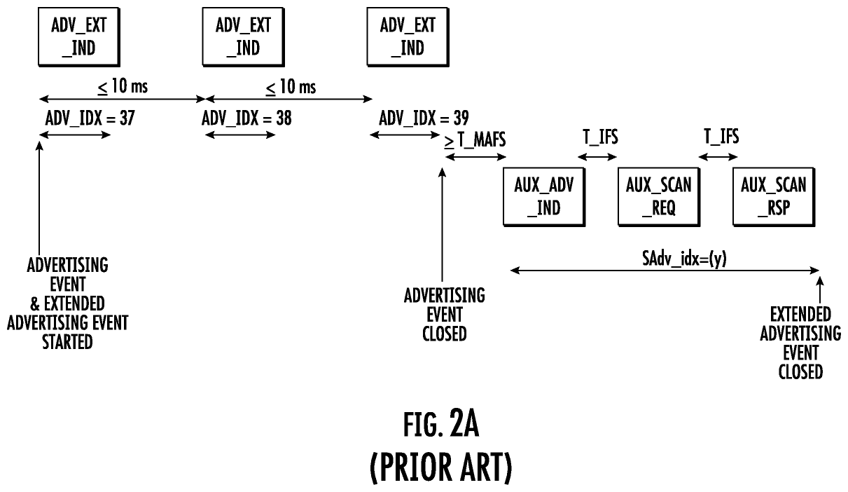

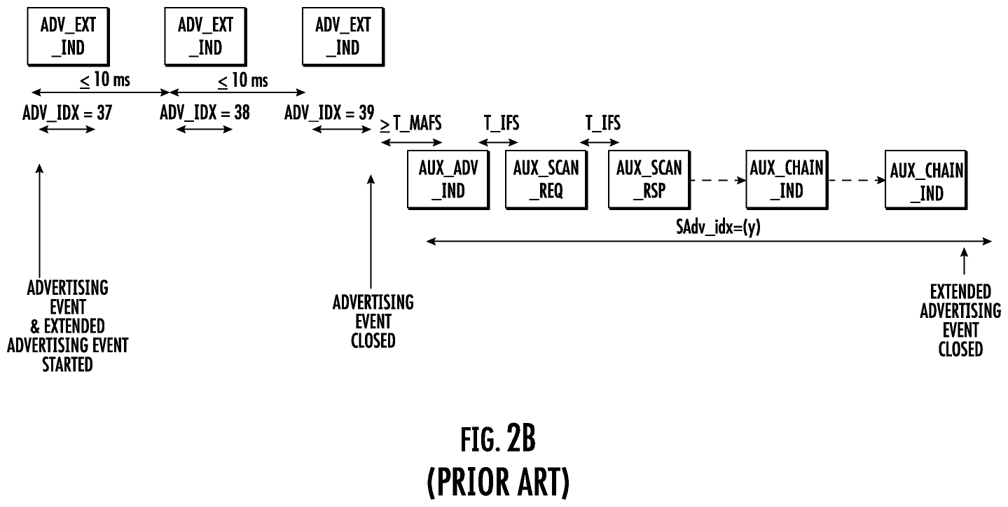

Later, in the Bluetooth Core specification, version 5, advertising was extended to allow for longer payloads, by adding new PDU types and by moving the payload data to Bluetooth Low Energy data channels, which are typically less congested than the advertising channels. FIG. 2A, taken from the Bluetooth Core specification, illustrates the message exchange during active scanning for extended advertising. For extended advertising, an ADV_EXT_IND PDU is used, which contains no payload data, but only information regarding the data channels that will be used to transmit the payload. As described above, the ADV_EXT_IND PDU may be transmitted on all three advertising channels. This is followed by an auxiliary advertisement, using a scannable AUX_ADV_IND PDU, which can contain up to 254 bytes of payload, and is transmitted on the data channel indicated by the ADV_EXT_IND PDU. Further, a device that is listening on the data channel may request a scan, using an AUX_SCAN_REQ PDU. This request is then followed by a scan response from the advertiser, using an AUX_SCAN_RSP PDU. Note that AUX_SCAN_RSP PDUs may contain more bytes than the SCAN_RSP PDUS. For example, AUX_SCAN_RSP PDUs may optionally include additional fields, such as ADI, auxiliary pointer, and Tx power. Note that, like the PDUs in FIG. 1, there are strict timing requirements regarding the AUX_SCAN_REQ and AUX_SCAN_RSP PDUs. As shown in FIG. 2A, the AUX_SCAN_REQ and AUX_SCAN_RSP PDUs must be transmitted after a duration, defined as the inter-frame spacing period (T_IFS), after receipt of the AUX_ADV_IND PDU and AUX_SCAN_REQ PDU, respectively. Further, like the SCAN_REQ PDU, the AUX_SCAN_REQ PDU contains no payload, only the Bluetooth address of the advertiser and the Bluetooth address of the device requesting the scan response. The only difference between these PDUs is the channel that they are transmitted on. After the scan request and response have been exchanged, the advertiser than moves to the next advertising channel. In certain embodiments, the response to the scan request may contain more information than can be included in a single AUX_SCAN_RSP PDU. In this scenario, as shown in FIG. 2B, the advertiser transmits additional response information using or one more AUX_CHAIN_IND PDUS. These AUX_CHAIN_IND PDUs are transmitted using the same or a different data channel as the AUX_SCAN_RSP PDU, and may vary in size.

One of the largest consumers of power in the advertiser is the transmit power. However, the Bluetooth protocol mandates that the advertiser transmit all of the PDUs described above.

Thus, in one embodiment, the advertiser attempts to reduce its power consumption through the use of reduced transmit power.

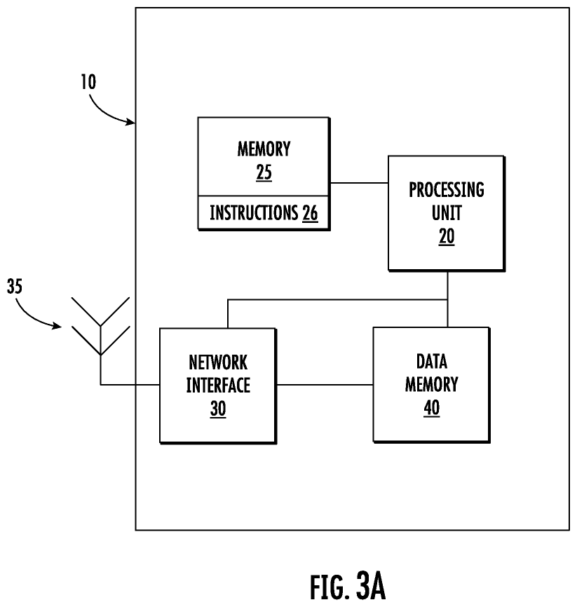

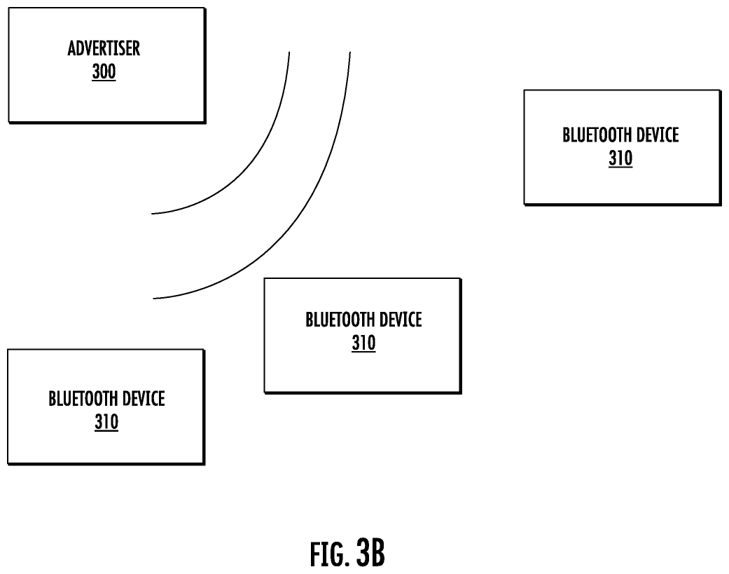

FIG. 3A shows a block diagram of a representative Bluetooth network device 10 that may be used to implement the disclosed method of minimizing power consumption used for advertisements in a Bluetooth network. This block diagram may be indicative of the structure of the advertiser.

The Bluetooth network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Bluetooth network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 3A. The second computer readable non-transitory media may be a CDROM, or a different memory device, which is located remote from the Bluetooth network device 10. The instructions contained on this second computer readable non-transitory media may be downloaded onto the memory device 25 to allow execution of the instructions by the Bluetooth network device 10.

The Bluetooth network device 10 also includes a Bluetooth network interface 30 that connects with a Bluetooth network using an antenna 35. The Bluetooth network interface 30 may include a read circuit to receive, demodulate, decode and store information transmitted to the Bluetooth network device 10. Further, the Bluetooth network interface 30 may include circuitry to enable the computation of the received signal strength indicator (RSSI) of an incoming signal. RSSI is typically calculated based on the signal strength of the received signal as measured by the read circuit. The Bluetooth network interface 30 may also include a transmit circuit that encodes and transmits outgoing information, typically through the use of a power amplifier. In certain embodiments, the transmit power used by the power amplifier may be programmable.

The Bluetooth network device 10 may include a data memory device 40 in which data that is received and transmitted by the Bluetooth network interface 30 is stored. This data memory device 40 is traditionally a volatile memory. The processing unit 20 has the ability to read and write the data memory device 40 so as to communicate with the other devices in the Bluetooth network.

Although not shown, the Bluetooth network device 10 also has a power supply, which may be a battery or a connection to a permanent power source, such as a wall outlet.

While the processing unit 20, the memory device 25, the Bluetooth network interface 30, and the data memory device 40 are shown in FIG. 3A as separate components, it is understood that some or all of these components may be integrated into a single electronic component. Rather, FIG. 3A is used to illustrate the functionality of the Bluetooth network device 10, not its physical configuration.

One approach to reduce power consumption is to use a reduce transmit power when transmitting the scan response PDU or auxiliary scan response PDU. FIG. 3B shows a Bluetooth network having an advertiser 300 and one or more Bluetooth devices 310.

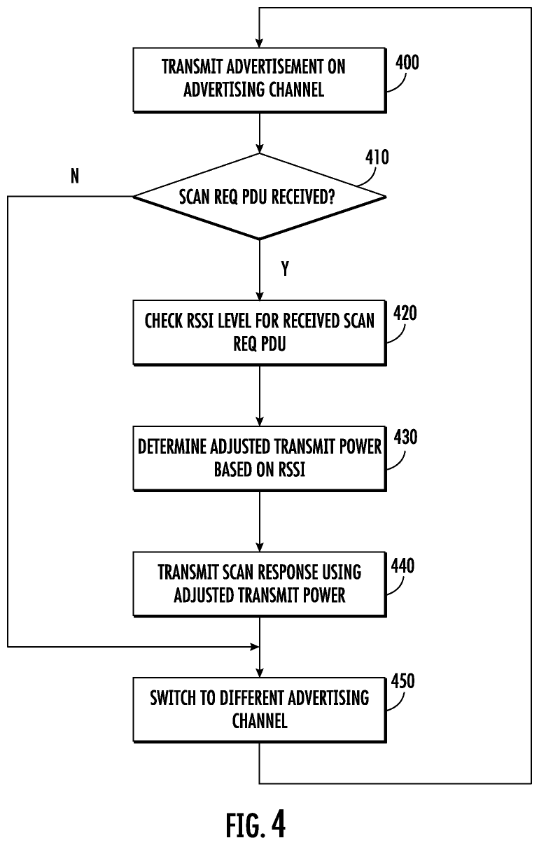

FIG. 4 shows a flowchart showing the operation of the advertiser 300 during a legacy advertising interval. First, as shown in Box 400, the advertiser 300 transmits an advertisement, using an ADV_IND PDU, on one of the advertising channels, as explained in FIG. 1. This advertisement is transmitted using the default transmit power. The advertiser 300 then waits to see if a scan request, in the form of a SCAN_REQ PDU, is received, as shown in Decision Box 410. If a SCAN_REQ PDU is received, the advertiser 300 checks the Receiver Signal Strength Indicator (RSSI) level of that PDU, as shown in Box 420. Techniques for determine the RSSI level are well known and will not be described herein.

There is an implicit assumption that if the RSSI of the incoming scan request PDU is high, the Bluetooth device 310 that transmitted that SCAN_REQ PDU is located relatively close to the advertiser 300. Conversely, if the RSSI of the incoming PDU is low, the Bluetooth device 310 that transmitted that SCAN_REQ PDU may be located relatively far away from the advertiser 300.

Consequently, if the RSSI is high, the advertiser 300 may reduce its transmit power when sending the scan response, in the form of a SCAN_RSP PDU, to the Bluetooth device 310. Conversely, if the RSSI is very low, the advertiser 300 may utilize its maximum transmit power when sending the SCAN_RSP PDU to the Bluetooth device 310. The transmit power is selected so as to be sufficiently high to ensure that the Bluetooth device 310 receives the SCAN_RSP PDU, while not consuming more power than required.

Thus, the advertiser 300 may use an equation, an algorithm or a look up table to determine the adjusted transmit power to use for the scan response PDU, based on the RSSI of the received scan request PDU, as shown in Box 430. In many embodiments, this is an inverse relationship wherein greater RSSI results in lower adjusted transmit power. For example, if the RSSI of the incoming signal is very high, the advertiser 300 may select a transmit power than is at least 10 dBm less than its maximum transmit power. For example, the advertiser 300 may select a transmit power of 0.01 mW (−20 dBm). Of course, this minimum transmit power may be adjusted, depending on the implementation. Conversely, if the RSSI of the incoming signal is low, the advertiser 300 may choose to use its maximum transmit power, which may be 100 mW (+20 dBm). In other embodiments, the maximum transmit power may be set to a lower value, such as +10 dBm or +6 dBm, if desired. Transmit power settings between these two extremes may be changed according to the RSSI. The transmit power settings may be discrete levels, such that a range of different RSSI levels result in the same transmit power. There may be a plurality of discreate levels, such as between 3 and 10 levels. This may be achieved using a lookup table. Alternatively, the transmit power may vary continuously based on RSSI. This may be achieved using an equation.

Then, as shown in Box 440, the advertiser 300 transmits the scan response, in the form of a SCAN_RSP PDU, using the adjusted transmit power, as determined above. Lastly, the advertiser 300 switches to a different advertising channel, as shown in Box 450. The sequence shown in FIG. 4 is then repeated. Note that if a scan request packet is not received, the advertiser 300 simply skips these intermediate steps and switches to the next advertising channel, as shown in Box 450.

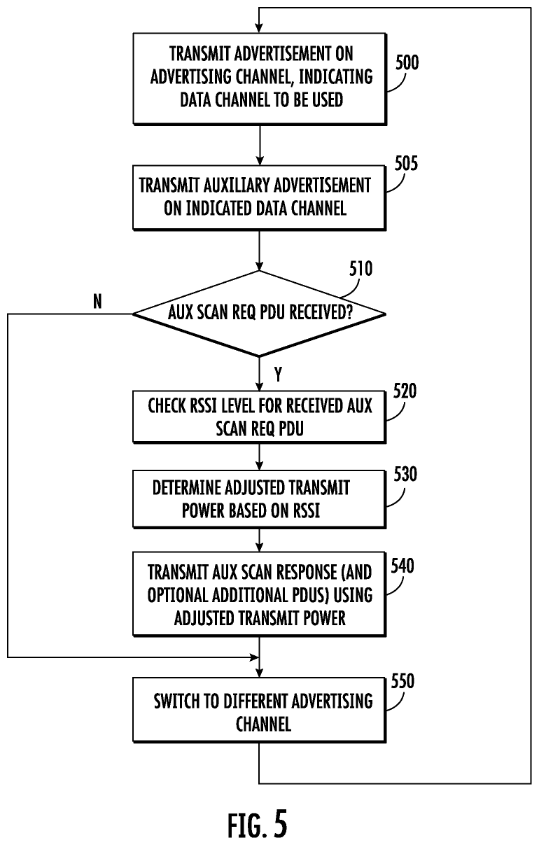

Note that FIG. 4 shows the modified sequence associated with legacy advertising, as shown in FIG. 1. However, this modification is also applicable to the extended advertising shown in FIGS. 2A-2B. This sequence is shown in FIG. 5. First, as shown in Box 500, the advertiser 300 transmits an advertisement, using an ADV_EXT_IND PDU, on one of the advertising channels, as explained in FIGS. 2A-2B. This PDU includes the data channel on which the auxiliary advertisement will be transmitted. This advertisement is transmitted using the default transmit power. The advertiser 300 then switches to the data channel indicated in the advertisement and transmits the auxiliary advertisement, in the form of an AUX_ADV_IND PDU, as shown in Box 505. This auxiliary advertisement may also be transmitted using the default transmit power. The advertiser 300 then waits to see if an auxiliary scan request, in the form of an AUX_SCAN_REQ PDU, is received on the data channel, as shown in Decision Box 510. If a AUX_SCAN_REQ PDU is received, the advertiser 300 checks the Receiver Signal Strength Indicator (RSSI) level of that PDU, as shown in Box 520. The advertiser 300 may then use an equation, an algorithm or a look up table to determine the adjusted transmit power to use for the auxiliary scan response PDU, based on the RSSI of the received auxiliary scan request PDU, as shown in Box 530. In many embodiments, as explained with respect to FIG. 4, this is an inverse relationship wherein greater RSSI results in lower adjusted transmit power. Then, as shown in Box 540, the advertiser 300 transmits the auxiliary scan response, in the form of an AUX_SCAN_RSP PDU, using the adjusted transmit power, as determined above. If there is additional information to transmit as part of the scan response, the advertiser 300 may transmit that information using one or more AUX_CHAIN_IND PDUs. The transmit power used for these AUX_CHAIN_IND PDUs is the same adjusted transmit power that was used for the auxiliary scan response. Lastly, the advertiser 300 switches to a different advertising channel, as shown in Box 550. The sequence shown in FIG. 5 is then repeated. Note that if an auxiliary scan request packet is not received, the advertiser 300 simply skips these intermediate steps and switches to the next advertising channel, as shown in Box 550.

Note that this adjusted transmit power is only used for scan response packets (SCAN_RSP PDUS, AUX_SCAN_RSP PDUS and AUX_CHAIN_IND PDUS that follow an AUX_SCAN_RSP PDU). All advertisements and auxiliary advertisements are still transmitted using the default transmit power, which may be maximum transmit power.

The present system and method have many advantages. First, the transmission of advertisements is very power intensive. By reducing the transmit power during scan responses, that power consumption is somewhat reduced. Further, this system and method can be implemented without any modification to the Bluetooth devices in the network. The advertiser simply uses signal strength of received signals to modify its operation without any knowledge or assistance from the Bluetooth device that transmitted the scan request. Additionally, the advertising channels are heavily used. By reducing the transmit power used for transmitting these scan response PDUs, other devices attempting to transmit on the same channel may encounter less interference, allowing higher throughput and fewer reties.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of transmitting advertisements from an advertiser to a Bluetooth device in a Bluetooth network, the method comprising a sequence of:
wirelessly transmitting, from the advertiser, an advertisement; and
in response to receiving a scan request packet from the Bluetooth device in response to the advertisement:
determining at the advertiser, the RSSI of the scan request packet;
setting an adjusted transmit power based on the RSSI of the scan request packet; and
transmitting, from the advertiser, a scan response packet to the Bluetooth device using the adjusted transmit power.

2. The method of claim 1, wherein the setting is performed using a look up table.

3. The method of claim 1, wherein the setting is performed using an algorithm or equation.

4. The method of claim 1, wherein the adjusted transmit power varies inversely with the RSSI.

5. The method of claim 4, wherein a difference between a minimum adjusted transmit power and a maximum adjusted transmit power is at least 10 dBm.

6. The method of claim 1, wherein the scan response packet is transmitted using a different transmit power than is used for the advertisement.

7. The method of claim 1, wherein after transmitting the scan response packet, the advertiser switches to a different channel and repeats the sequence.

8. The method of claim 1, wherein the advertisement, the scan request packet and the scan response packet are transmitted on an advertising channel.

9. The method of claim 1, wherein the advertisement, the scan request packet and the scan response packet are transmitted on a data channel.

10. The method of claim 9, wherein information to be sent from the advertiser to the Bluetooth device in response to the scan request packet cannot all be contained within the scan response packet and wherein the advertiser transmits additional response packets using the adjusted transmit power.

11. The method of claim 9, further comprising transmitting an initial advertisement on an advertising channel prior to transmitting the advertisement on the data channel.

12. A Bluetooth network device, comprising:
a network interface including:
a read circuit to receive, demodulate and decode an incoming packet and to determine a received signal strength indicator (RSSI) for the incoming packet; and
a power amplifier configured to transmit packets at a selectable transmit power;
a processing unit; and
a memory device, in communication with the processing unit, containing instructions, which when executed by the processing unit, enable the Bluetooth network device to:
wirelessly transmit an advertisement; and
in response to receiving a scan request packet in response to the advertisement:
determine the RSSI of the scan request packet;
set an adjusted transmit power based on the RSSI of the scan request packet; and
transmit a scan response packet using the adjusted transmit power.

13. The Bluetooth network device of claim 12, wherein the processing unit uses a look up to set the adjusted transmit power.

14. The Bluetooth network device of claim 12, wherein the processing unit uses an equation or algorithm to set the adjusted transmit power.

15. The Bluetooth network device of claim 12, wherein the adjusted transmit power varies inversely with the RSSI.

16. The Bluetooth network device of claim 12, wherein the advertisement and the scan response packet are transmitted on an advertising channel.

17. The Bluetooth network device of claim 12, wherein the advertisement and the scan response packet are transmitted on a data channel.

18. The Bluetooth network device of claim 17, wherein information to be sent from the Bluetooth network device in response to the scan request packet cannot all be contained within the scan response packet and further comprising instructions, which when executed by the processing unit, enable the Bluetooth network device to transmit additional response packets using the adjusted transmit power.

19. The Bluetooth network device of claim 17, further comprising instructions, which when executed by the processing unit, enable the Bluetooth network device to transmit an initial advertisement on an advertising channel prior to transmitting the advertisement on the data channel.

20. The Bluetooth network device of claim 12, wherein the scan response packet is transmitted using a different transmit power than is used for the advertisement.
